(19) United States
(12) Patent Application Publication
(10) Pub. No.: US 2023/0153904 A1
(43) Pub. Date: May 18, 2023

(54) SYSTEMS AND PROCESSES FOR PEER-TO-PEER FINANCIAL INSTRUMENT TRANSACTIONS

(71) Applicant: GABRIENNE TRADING SYSTEMS (PTY) LTD, Gauteng (ZA)

(72) Inventors: Tyronne VAN NIEKERK, Johannesburg (ZA); Brett Lyle MAHON, Johannesburg (ZA)

(21) Appl. No.: 17/925,265

(22) PCT Filed: May 15, 2020
(86) PCT No.: PCT/IB2020/054634

§ 371 Date: Nov. 14, 2022

(51) Int. Cl. G06Q 40/04

(52) U.S. Cl. CPC G06Q 40/04

(57) ABSTRACT

The invention relates to systems and processes for enabling the execution of a peer-to-peer financial instrument transaction. More specifically, the invention relates to a system and processes for executing a peer-to-peer financial instrument transaction, a system and process for generating a quote in the system for executing a peer-to-peer financial instrument transaction, and a process for presenting a price level component matrix in an interface module of the system for executing a peer-to-peer financial instrument transaction.

### INTRODUCTION AND BACKGROUND

The invention relates to systems and processes for enabling the execution of a peer-to-peer financial instrument transaction. More specifically, the invention relates to a system and processes for executing a peer-to-peer financial instrument transaction, a system and process for generating a quote in the system for executing a peer-to-peer financial instrument transaction, and a process for presenting a price level component matrix in an interface module of the system for executing a peer-to-peer financial instrument transaction.

It is to be appreciated that there are many electronic trading systems throughout the markets of the world. Yet, in certain markets, most of the transaction volume is still attended to through human brokers (over the telephone) at a large cost. Examples of these include the interbank fixed-income market (serviced extensively by Interdealer Brokers) and certain institutional OTC markets. This continues to be true even when electronic trading systems exist in these markets.

The reason for this lies in the level of service that a human broker offers that current electronic trading systems do not. Accordingly, the existing electronic trading systems have a combination of disadvantages which render them inferior for executing certain financial instrument transactions when compared to a human broker.

One such disadvantage is a lack of data privacy in the process leading up to a transaction. Where pending transactional data is published to the market, such as the transaction amount, it can have a significant detrimental impact (such as through “spooking the market”) on market activity. A skilled human broker can manage large transactions through his client network without this side effect.

A further disadvantage is the lack of ability to natively execute multi-legged (multi-instrument) trades in the market. The data privacy disadvantage becomes compounded in this case. A human broker is able to manage multiple legs (and the associated price relationship between them) with minimal market impact with relative ease through his network of clients.

Furthermore, a human broker is able to engage in post-trade negotiation with his clients. Current electronic trading systems (even with the addition algorithmic trading) cannot do this. Because a human broker knows the intention of his clients, he can negotiate on behalf of them. For example, should a party have traded with a counterparty and a party wishes to execute additional volume with the other, the broker is able to facilitate that transaction in conversation.

Finally, it is to be appreciated that it is of paramount importance that in a viable electronic trading system the market data should be available in real time, while also managing transactional concurrency, as multiple financial instruments are traded at any given moment by any number of parties. Should a party execute a transaction on a financial instrument held by another party which has already been the subject of a transaction with a third party (due to market data capturing delays or flawed concurrency management) it would be fatal to the electronic trading system and catastrophic to the parties involved.

Existing electronic trading systems have to date not established the systems and processes which sufficiently addresses the abovementioned disadvantages and problems to allow for peer-to-peer financial instrument transactions.

### OBJECT OF THE INVENTION

Accordingly, it is an object of the present invention to provide systems and processes with which the applicant believes the aforementioned disadvantages and problems may at least partially be overcome.

### SUMMARY OF THE INVENTION

According to a first aspect of the invention there is provided a system for executing a peer-to-peer financial instrument transaction, the system comprising:
an interface module of an active user of the system for:
   presenting a price level component of an open tradable quote associated with one or a plurality of subject financial instruments to the active user, and
   receiving input quote data of the active user;
a business logic module for:
   receiving the input quote data from the interface module,
   optionally, creating an active user query object from the input quote data,
   exchanging data with a database of financial instrument transaction data by means of the input quote data or, where created, through the active user query object to execute the financial instrument transaction, and
   generating a financial instrument transaction outcome from the data exchange; and
a notification module for sending a notification on the financial instrument transaction outcome to the interface module and thereby updating the interface module.

An interface module may be a user interface or a machine interface. The user interface may be a graphical user interface or a console user interface.

A financial instrument transaction may be one of the purchase, sale and/or exchange of one or a plurality of subject financial instruments (which term is intended to include derivative financial instruments). Furthermore, the one or plurality of subject financial instruments may be selected from one or a plurality of financial instrument types. The financial instrument types may be bonds and interest rate derivatives, however, as those skilled in the art would appreciate, need not be in any way limited to the above specified financial instrument types as a financial instrument is a monetary contract between parties, including such contracts in the context of commodities, blockchain assets and securities (as examples of fungible assets traded on private or public exchanges and markets).

A business logic module may comprise an application programming interface (API) module and a data access module, the API module being disposed between the interface module and the data access module. The API module may include a set of functions and associated logic to relay data from the interface module to the data access module. The data access module may include a set of functions and associated logic to exchange data with the database.

A price level component may be an interactive interface component comprising user accessible data and non-user accessible data.

An open tradable quote is a quote which is not only presented to the active user. The open tradable quote may be presented via a price level component of the open tradable quote to all users within the system or an ecosystem of a passive user who generated the open tradable quote. The open tradable quote may be generated in the system in accordance with the fourth and fifth aspects of the invention.

A price level component of an open tradable quote comprises, as the user accessible data, a trade price level, and as the non-user accessible data, a financial instrument identifier and a bid/offer status indicating whether the open tradable quote is a bid or an offer.

A tradable quote as a bid is a quote whereby a passive user commits to buy one or a plurality of financial instruments in a defined amount at a defined price level.

A tradable quote as an offer is a quote whereby a passive user commits to sell one or a plurality of financial instruments in a defined amount at a defined price level.

The defined amount may be a nominal amount for physical instruments or may be a notional amount for derivatives or may be another metric specific to the quantity of the one or plurality of subject financial instrument type(s).

Where the price level component is of an open tradable quote as a bid or an offer, the input quote data may comprise:
the financial instrument identifier and a buy/sell status which may be derived from the price level component bid/offer status;
an input amount which the active user is interested in selling or buying; and
an input price level at which the active user is interested in selling or buying the input amount.

The input price level may match the trade price level of the price level component.

The active user query object may comprise:
an active user identifier,
the financial instrument identifier,
the input amount,
the input price level, and
the buy/sell status.

The data exchange may be a plurality of exchanges.

A first exchange may comprise:
retrieving a list of all or some open tradable quotes of passive users with a defined price level at and/or more favourable for the active user than the input price level in the database for such open tradable quotes which have a bid/offer status commensurate with the buy/sell status; and
establishing a final list of executable tradable quotes from the list of all open tradable quotes retrieved.

A second data exchange may be sequential and iterate through the final list of executable tradable quotes. An iteration sequence is preferably:
the business logic module retrieving an open tradable quote record associated with the open tradable quote from the database;
the business logic module sending instructions to the database to create a trade record between the active user and a passive user of the open tradable quote;
if the trade record is not successfully created in the database, the business logic module receiving feedback from the database where in response, the business logic module exiting the sequence and starting with the next open tradable quote; and
where the trade record is created, the business logic module determining a remaining amount from the input amount.

Where a trade record is created in the database in an iteration, a trade is realised between the active user and the passive user of the open tradable quote of that iteration. A quote status in the open tradable quote record of the open tradable quote may be set to filled if the defined amount of the open tradable quote is depleted by the trade.

When the second data exchange is concluded, the business logic module may generate the financial instrument transaction outcome. The financial instrument transaction outcome may be one of:
a failure where no trade record is successfully created in the database,
a partial success, and
a success.

Where the financial instrument transaction outcome is a success or a partial success, the financial instrument transaction comprises the trade or trades so realised.

The system may further include a plurality of interface modules of users of the system. The users may be passive users. The passive users may be passive users in an ecosystem of the active user. Each such interface module may receive the notification via the notification module and so update the interface module in accordance with the financial instrument transaction outcome through updating the price level components of the open tradable quote or quotes on which the trade or trades are realised. The updating of the price level components of the open tradable quote or quotes on which the trade or trades are realised may be done by presenting a price component matrix in accordance with the sixth aspect of the invention.

The financial instrument transaction may comprise one or a plurality of trades, depending on the input amount of the active user and the defined amounts of the open tradable quotes in the final list of executable tradable quotes for which a trade is realised. Where the financial instrument transaction comprises a plurality of trades, it is to be appreciated that the transaction may comprise trades realised on open tradable quotes of different passive users and not only a single passive user.

If, during an iteration in the second data exchange, the remaining amount is wholly depleted by a trade, and the defined amount of the open tradable quote of that iteration is not wholly depleted by the trade, the subject iteration may be the last iteration of the second data exchange, the subject last iteration further including the steps of:

optionally, setting a quote status of the open tradable quote record of the open tradable quote to locked;
sending a notification to the interface module of the active user via the notification module, the notification comprising the financial instrument identifier, the input price level and an option to the active user to provide a further input amount;
optionally, receiving from the active user the further input amount via the interface module of the active user;
where the further input amount is received from the active user:
   passing the further input amount to the business logic module from the interface module of the active user, and
   sending instructions from the business logic module to the database to create a trade record between the active user and a passive user of the open tradable quote; or
where the quote status has been set to lock and where no further input amount is received from the active user, setting the quote status of the open tradable quote record associated with the open tradable quote to unlocked.

If, at the conclusion of the second data exchange, the remaining amount of the input amount is not wholly depleted, a private tradable quote of the active user may be generated in the system, the private tradable quote may comprise the financial instrument identifier, a quote status as private, an active user reference, a bid/offer status, a private quote amount as the remaining amount after the second data exchange is concluded and a private quote price level as the input price level.

One or a plurality of passive users of an open tradable quote in the final list of executable tradable quotes may be presented with an option to execute a financial instrument transaction on the private tradable quote of the active user via the interface module of the one or plurality of passive users by means of a notification via the notification module. Preferably, the option to execute a financial instrument transaction on the private tradable quote is presented to the passive user who first generated an open tradable quote in the final list of executable tradable quotes. Consequently, the passive user may now become an active user and the active user become a passive user in accordance with the third aspect of the invention.

A financial instrument identifier may comprise one or a plurality of financial instrument specific keys corresponding to the one or plurality of subject financial instruments. The financial instrument specific key or keys map the price level component to a data table or data tables in the database.

A price level component may be presented to the active user as part of a price level component matrix in accordance with the sixth aspect of the invention. Where the price level component is presented to the active user in a column matrix of quotes as bids or offers, the financial instrument identifier may comprise n-financial instrument specific keys where n is the number of subject financial instruments associated with the quote of the price level component. Where the price level component is presented to the active user in a multi-column matrix of one of quotes as bids or offers, the financial instrument identifier may comprise a row key and a column key of the matrix.

According to a second aspect of the invention there is provided a process for executing a peer-to-peer financial instrument transaction on an open tradable quote, the process comprising the steps of:
presenting via an interface module a price level component of an open tradable quote associated with one or a plurality of subject financial instruments to an active user of the system;
receiving via the interface module input quote data of the active user;
receiving at a business logic module the input quote data from the interface module;
creating an active user query object from the input quote data in the business logic module;
exchanging data with a database of financial instrument transaction data via the business logic module by means of the active user query object to execute the financial instrument transaction;
generating a financial instrument transaction outcome from the data exchange in the business logic module; and
sending a notification on the financial instrument transaction outcome to the interface module via a notification module and thereby updating the interface module.

According to a third aspect of the invention there is provided a process for executing a peer-to-peer financial instrument transaction on a private tradable quote, the process comprising the steps of:
presenting an option to execute a financial instrument transaction on the private tradable quote to an active user via an interface module, the option including a financial instrument identifier, a private quote price level and a private quote amount of the private tradable quote;
receiving private input quote data of the active user via the interface module;
passing the private input quote data to a business logic module;
sending instructions comprising the private input quote data from the business logic module to a database of financial instrument transaction data to create a trade record between the active user and a passive user of the private tradable quote; and
sending a notification to the interface module via a notification module informing of the trade record and thereby updating the interface module.

The private input quote data may comprise any one or a combination of the financial instrument identifier, a private quote identifier (which may by a unique ID, a combination of parameters of the private tradable quote or any other means through which to identify the private tradable quote), a buy/sell status, an input price level as the private quote price level and an input amount. Preferably, the private input quote data may comprise the private quote identifier.

The step of presenting an option to execute a financial instrument transaction on the private tradable quote to the active user via an interface module may be preceded by a request for quote (RFQ) process, the RFQ process comprising the steps of:
receiving RFQ response quote data of the active user via the interface module;
passing the RFQ response quote data from the interface module to a business logic module;
creating an RFQ object in the business logic module;
sending an RFQ notification via the notification module to an interface module of a passive user and thereby displaying an RFQ notice to the passive user; and
optionally, generating a private tradable quote by the passive user in the system, the private tradable quote comprising of a private quote price level, a private quote amount, a quote status as private and an active user reference.

The RFQ response quote data may be received from the active user via the interface module by means of a price level component of an indicative market price level quote.

Where the price level component is of an indicative market price level quote, the price level component may comprise, as user accessible data, a market price level, and as non-user accessible data, a financial instrument identifier and a bid/offer status based on whether the indicative market price level quote is of the purchase or sale of the one or a plurality of subject financial instruments.

The market price level relates to the price level of the financial instrument type(s) of the one or plurality of subject financial instrument(s) when bought or sold in a given market. Accordingly, the market price level may be an interest rate, spread, cash price or other form of market determined price level.

The RFQ response quote data may comprise:
a financial instrument identifier; and
an RFQ amount which the active user is interested in buying or selling.

The RFQ amount may be a nominal amount for physical instruments or may be a notional amount for derivatives or may be another metric specific to the quantity of the one or plurality of subject financial instrument type(s).

The RFQ object may comprise:
the financial instrument identifier; and
the RFQ amount.

Preferably, there may be a plurality of interface modules of a plurality of passive users in the system. Each of the interface modules may receive the RFQ notification via the notification module to display the RFQ notice. The RFQ notice of a passive user may comprise:
a display of the financial instrument identifier and the RFQ amount obtained from the RFQ object; and
a request for a private tradable quote.

The request for a tradable quote may only be open for a predetermined time period. The predetermined time period may be any market appropriate time period, preferably less than 60 seconds.

A passive user generated private tradable quote may comprise the financial instrument identifier, a quote ID, a quote status as private, an active user reference, a passive user defined bid/offer status, a private quote amount and a private quote price level as a passive user defined price level.

The private quote status and the active user reference of the passive user generated private tradable quote may be used in the system to present the option to execute a financial instrument transaction on the private tradable quote to the active user via the interface module of the active user.

It is to be appreciated that the interface modules may not be of the same type (by example, electronic web interface(s) wherein the RFQ notice is a pop-up dialog box and console user interface(s) wherein the RFQ notice is text).

According to a fourth aspect of the invention there is provided a system for generating an open tradable quote in a peer-to-peer financial instrument transaction, the system comprising:
an interface module for:
   receiving tradable quote data associated with one or a plurality of subject financial instruments of a user in the system, the tradable quote data comprising a financial instrument identifier, a bid/offer status, a defined amount and a defined price level;
a business logic module for:
   receiving the tradable quote data from the interface module, and
   creating an open tradable quote record in a database of financial instrument transaction data from the tradable quote data, and thereby generating the open tradable quote; and
a notification module for sending a notification to the interface module informing of the creation of the open tradable quote record.

Once the interface module has received the tradable quote data of the user, the user becomes a passive user in accordance with the first and second aspects of the invention.

The tradable quote data may further comprise a quote type identifier.

The open tradable quote record may include a quote status as active.

The business logic module may comprise an application programming interface (API) module and a data access module, the API module disposed between the interface module and the data access module. The API module may:
receive the tradable quote data from the interface module and create a tradable quote object comprising the tradable quote data from an object template retrieved from an object template library, the object template based on the quote type identifier of the tradable quote data; and
pass the tradable quote object to the data access module.

The data access module may then receive the tradable quote data as part of the tradable quote object and create the open tradable quote record in the database to generate the open tradable quote.

In response to receipt of the notification, the interface module may present a subject price level component matrix comprising the price level component of the open tradable quote in accordance with the sixth aspect of the invention. Preferably, there will be a plurality of interface modules of a plurality of users, each of the plurality of interface modules receiving the notification form the notification module and, in response, presenting the subject price level component matrix comprising the price level component of the open tradable quote in accordance with the sixth aspect of the invention.

According to a fifth aspect of the invention there is provided a process for generating an open tradable quote in a peer-to-peer financial instrument transaction, the process comprising the steps of:
receiving via an interface module, tradable quote data associated with one or a plurality of subject financial instruments of a user, the tradable quote data comprising a financial instrument identifier, a bid/offer status, a defined amount and a defined price level;
passing the tradable quote data from the interface module to a business logic module;
creating via the business logic module, an open tradable quote record in a database of financial instrument transaction data from the tradable quote data, and thereby generating the open tradable quote; and
sending via a notification module, a notification to the interface module informing of the creation of the open tradable quote record.

According to a sixth aspect of the invention there is provided a process for presenting a price level component matrix in an interface module of a system for executing a peer-to-peer financial instrument transaction, the process comprising the steps of:
receiving via the interface module an instruction to generate the price level component matrix comprising one or a plurality of cells, a cell comprising one or a plurality of price level components, each price level component of a quote associated with one or a plurality of subject financial instruments;
requesting via the interface module a business logic module to generate the price level component matrix and passing request data comprising a matrix identifier to the business logic module;
generating via the business logic module a quote data map object corresponding to the price level component matrix to be generated as specified by the matrix identifier, the quote data map object mapping quote records of the one or plurality of subject financial instruments of the one or plurality of price level components in a database of financial instrument transaction data to the one or plurality of cells of the price level component matrix to be generated;
for each of the one or plurality of cells, via the business logic module:
   retrieving an open tradable quote list from the database corresponding to the cell by means of the quote data map object, and
   creating a cell-specific final quote list;
generating in the business logic module a matrix object comprising of a price level of each quote in each cell-specific final quote list for each of the one or plurality of cells in the price level component matrix to be generated;
passing the matrix object from the business logic module to the interface module;
rendering the price level component matrix by means of the matrix object in the interface module; and
presenting in the interface module the price level component matrix so rendered.

The instruction to generate the price level component matrix may occur in the event of one or a combination of the following:
a change in a state of the one or plurality of quotes;
a change in a state of an ecosystem of a user;
when a trade is realised on the one or plurality of quotes as an open tradable quote in accordance with the first and second aspects of the invention;
an interface module refresh or load command; and
user login to the system.

The business logic module may comprise an application programming interface (API) module, a matrix data structuring module and a data access module. The API module may relay the request to generate the price level component matrix and the request data from the interface module to the matrix data structuring module.

Furthermore, the matrix data structuring module may generate the quote data map object. Further still, the matrix data structing module may, for each of the one or plurality of cells:
retrieve via the data access module the open tradable quote list from the database corresponding to the cell by means of the quote data map object, and
create the cell-specific final quote list.

Further still, the API module may relay the matrix object from the matrix data structing module to the interface module.

The process step of creating the cell-specific final quote list may include a step of generating an indicative market price level quote from a real time market price of each of the one or plurality of subject financial instruments.

The process step of creating the cell-specific final quote list may further include of a step of sorting and filtering the open tradable quote list. The open tradable quote list may be sorted in ascending or descending defined price level order. The open tradable quote list may be filtered such that:
only open tradable quotes with a quote status as active are retained; and
if an open tradable quote from the user associated with the interface module does not exist in the tradable quote list, then only the tradable quote of a passive user at the top of the list once sorted is retained.

### BRIEF DESCRIPTION OF THE ACCOMPANYING DIAGRAMS

The invention will now further be described, by way of example only, with reference to the accompanying diagrams wherein:

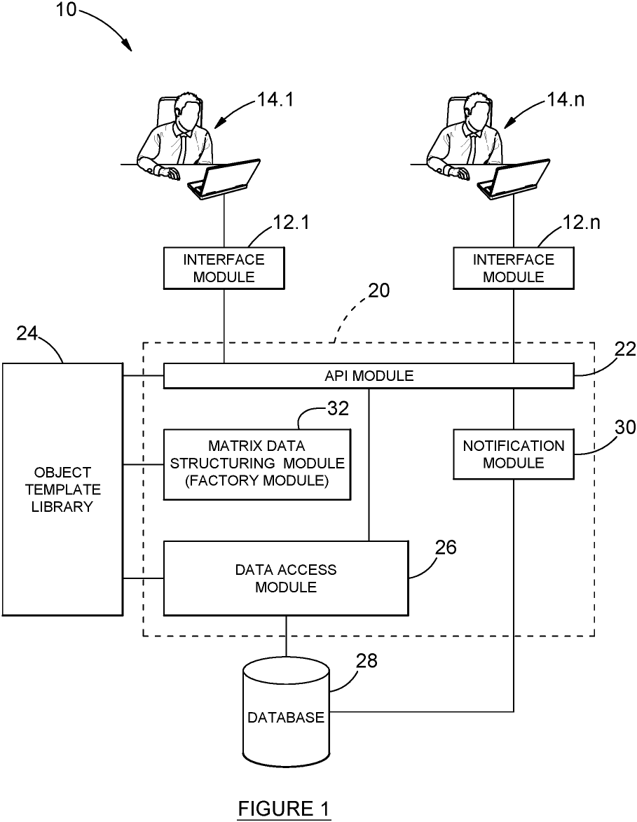

FIG. 1 is a schematic diagram illustrating a system for executing a peer-to-peer financial instrument transaction;

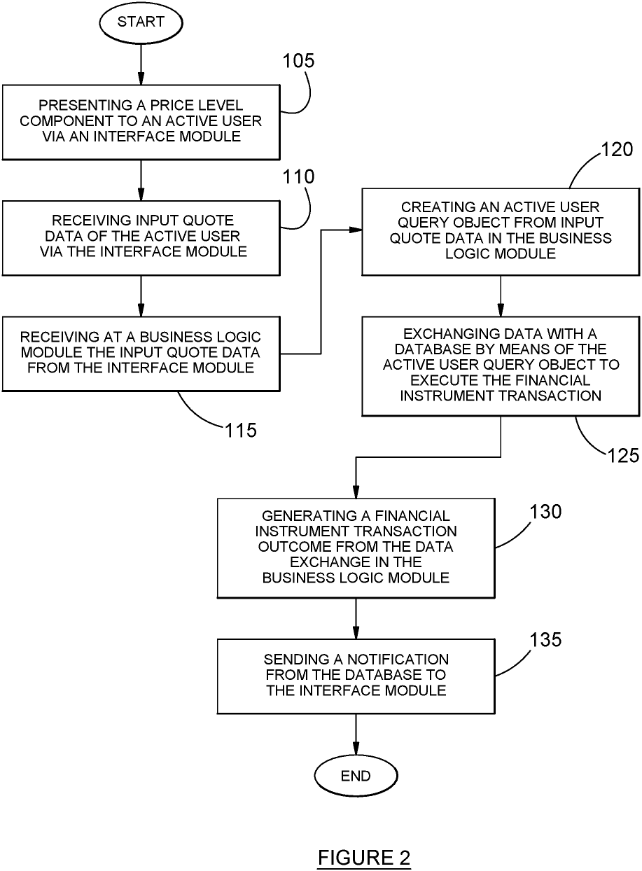

FIG. 2 is a process flow diagram illustrating a process for executing a peer-to-peer financial instrument transaction on an open tradable quote;

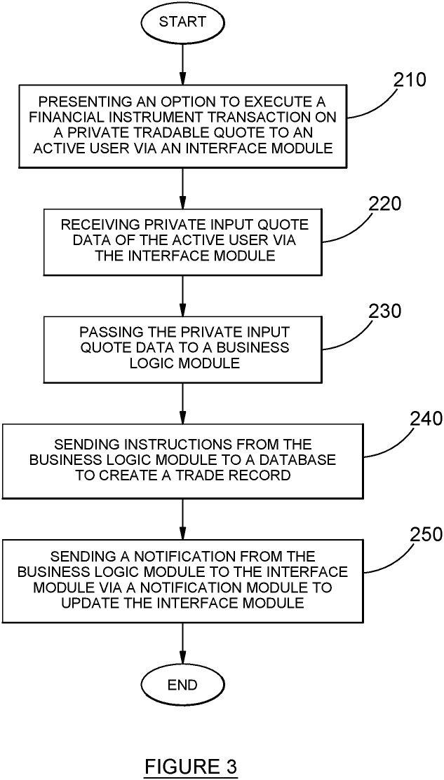

FIG. 3 is a process flow diagram illustrating a process for executing a peer-to-peer financial instrument transaction on a private tradable quote;

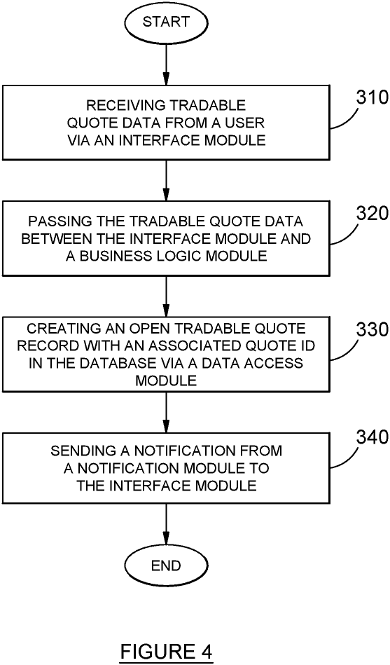

FIG. 4 is a process flow diagram illustrating a process for generating an open tradable quote in the system of FIG. 1;

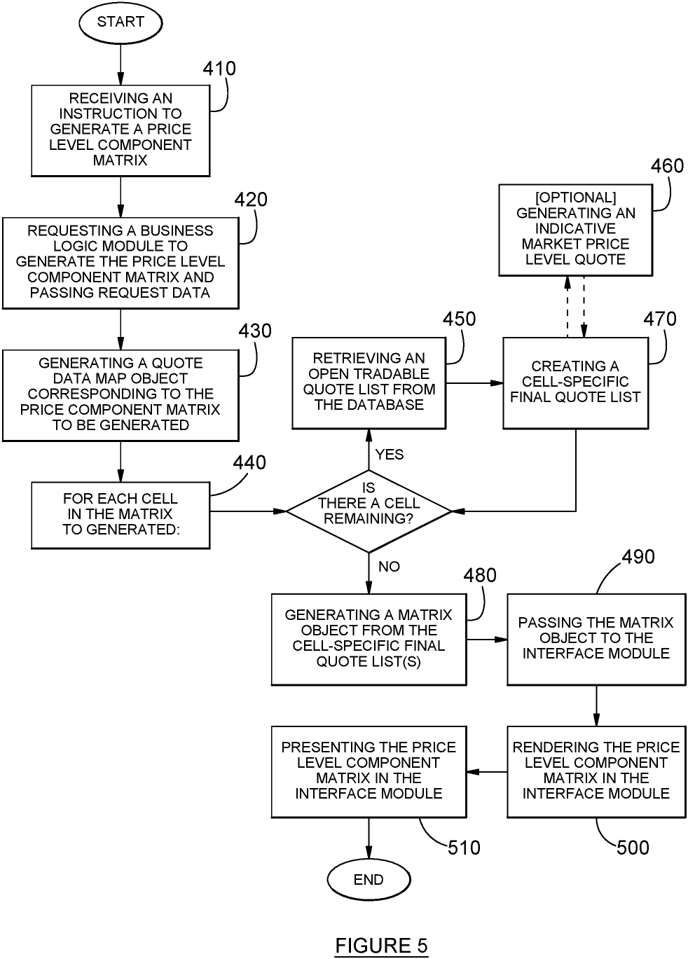

FIG. 5 is a process flow diagram illustrating a process for presenting a price level component matrix in an interface module of the system of FIG. 1;

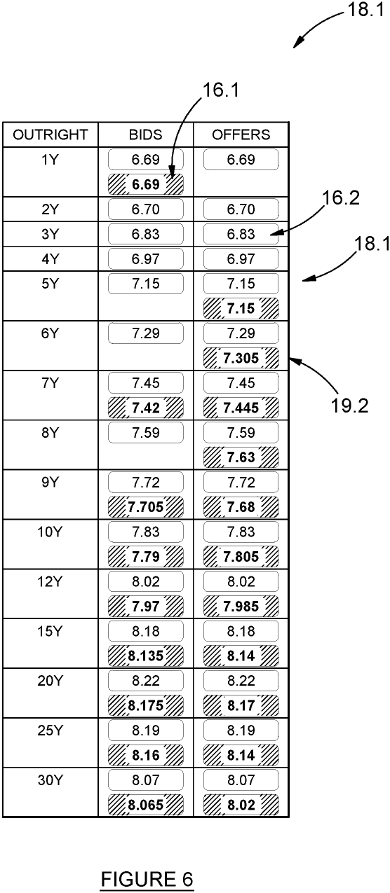

FIG. 6 is a first example price level component matrix as presented in an interface module in accordance with the process of FIG. 5;

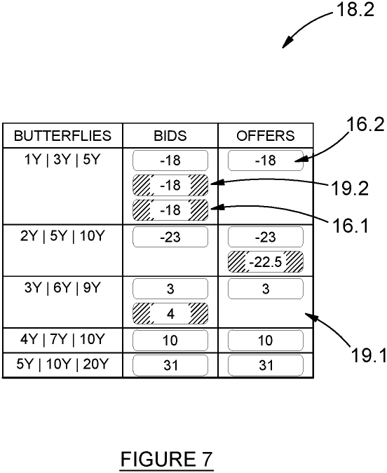

FIG. 7 is a second example price level component matrix as presented in an interface module in accordance with the process of FIG. 5; and

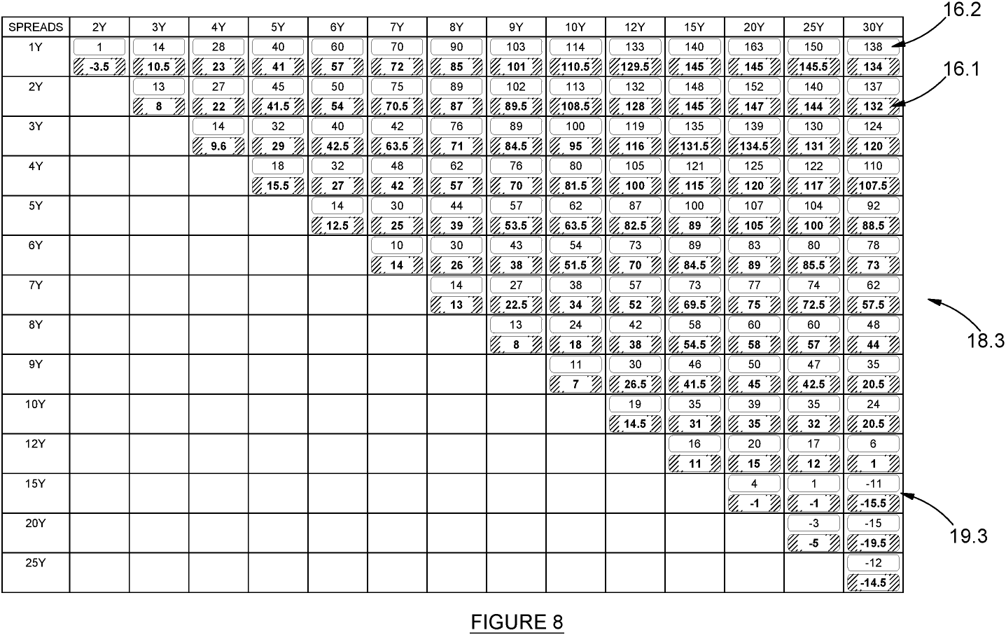

FIG. 8 is a third example price level component matrix as presented in an interface module in accordance with the process of FIG. 5.

### DESCRIPTION OF PREFERRED EMBODIMENTS OF THE INVENTION

FIG. 1 shows a system 10 for executing a peer-to-peer financial instrument transaction.

As will be apparent from this description, “peer-to-peer” refers to the execution of the financial instrument transaction between parties to the financial instrument transaction, represented by (or as) users 14 of the system 10. To exemplify user 14 representation, a user 14 can be a trader at an investment bank, the trader representing the investment bank as a party to the financial instrument transaction. However, a user 14 may self be a party to the financial instrument transaction.

Furthermore, “executing” with reference to the financial instrument transaction in the present context refers to creating or amending (in the case of derivative financial instruments) an obligation to convey the one or more subject financial instruments of the financial instrument transaction. The conveyance is intended to occur outside of the system 10 of the invention and may be performed between the parties in a direct nature or may be indirect through the use of a third-party intermediary such as a clearing house.

Further still, reference to a financial instrument transaction includes reference to a transaction incorporating a plurality of subject financial instruments. In this regard, a financial instrument transaction can include: the outright purchase or sale of a single financial instrument, or a set (plurality) thereof, such as bonds, swaps, forward rate agreements and forward swaps; as well as the simultaneous purchase and sale (exchange) of such financial instruments (also known as “multi-leg trades”), such as spreads (where one instrument is bought and another is sold), packs (a spread where one instrument is a bond and the other is a swap) and butterflies (where there are three instruments, the first and third being purchased and the second being sold).

Accordingly, “quote” in this context refers to one of a bid (which can be at a market determined price level, i.e. market price level, or a user 14 determined price level, such as a defined and tradable price level) or an offer (which can be at a market determined price level, i.e. market price level, or a user 14 determined price level, such as a defined and tradable price level) for such a subject financial instrument, or set (plurality) thereof.

Further, it is to be appreciated that a notification via a notification module 30 can be implemented in any known way, including the sending of the notification in response to the timed polling by the interface module 12 of the database 28 of financial instrument transaction data as well as asynchronous notifications, such as through the use of the SignalR software library.

Finally, it is to be appreciated that the invention described herein below is not to be limited in scope by the specific examples, as the examples are intended as illustrative of several aspects of the invention. Any equivalent embodiments are intended to be within the scope of the invention, as they will become apparent to those skilled in the art from the present description.

### Example 1: Executing a Financial Instrument Transaction on an Open Tradable Quote

This example is with reference to FIGS. 1, 2, 6, 7 and 8 showing the system 10 for executing a peer-to-peer financial instrument transaction and a process for executing such a financial instrument transaction on an open tradable quote for which a price level component 16 is presented in a price component matrix 18.

The system 10 is shown to comprise a plurality of interface modules 12.1 to 12.n. Each interface module 12.1 to 12.n being of a user 14.1 to 14.n of the system. An interface module 12 of this example is an electronic web user interface (UI) and the transmission of data between modules and the database 28 in the system 10 is of any known type as will become apparent to a person skilled in the art through the examples.

With reference to the interface module 12.1 of an active user 14.1 of the system 10, the interface module 12.1 presents 105 price level components 16 (as shown in FIGS. 6 through 8) in price level component matrices 18 (as shown in FIGS. 6 through 8) to the active user 14.1. The price level component matrices 18 are shown to comprise a plurality of cells 19, a cell 19 comprising of one (such as a cell 19.1) or a plurality (such as a cell 19.2) of price level components 16 of one or a plurality of subject financial instruments identifiable in the example matrices 18 by row and/or column headers. In a column matrix, the one (as shown in FIG. 6) or plurality (as shown in FIG. 7) of subject financial instruments is identifiable by the row header and, in a multi-column matrix, the one or plurality (as shown in FIG. 8) of subject financial instruments is identifiable by the row and column header.

In this regard, FIG. 6 shows price level component column matrices 18.1 of price level components 16 (in cells 19 of the matrix 18.1) of indicative market price level quotes (price level components 16.2 shown with a non-cross hatched background) and open tradable quotes (price level components 16.1 shown with a cross hatched background), for the outright purchase or sale of swaps. Accordingly, each of the price level component column matrices 18.1 corresponds to one of quotes as bids and quotes as offers (indicated by the relevant column header).

FIG. 7 shows price level component column matrices 18.2 of price level components 16 (in cells 19 of the matrix 18.2) of indicative market price level quotes (price level components 16.2 shown with a non-cross hatched background) and open tradable quotes (price level components 16.1 shown with a cross hatched background), for the purchase or sale of butterflies. Accordingly, each of the price level component matrices 18.2 corresponds to one of quotes as bids and quotes as offers (indicated by the relevant column header).

FIG. 8 shows a price level component multi-column matrix 18.3 of price level components 16 (in cells 19 of the matrix 18.3) of indicative market price level quotes (price level components 16.2 shown with a non-cross hatched background) and open tradable quotes (price level components 16.1 shown with a cross hatched background) for swap spreads. The price level component multi-column matrix 18.3 may correspond to one of quotes as bids or quotes as offers.

As seen from FIGS. 6, 7 and 8, the price level component 16.1 of an open tradable quote comprises, as user accessible data, a trade price level. The price level component 16.1 further comprises, as non-user accessible data, a financial instrument identifier and a bid/offer status indicating whether the open tradable quote is a bid or an offer (which can be derived from the matrix 18 in which the price level component 16 is presented).

It is to be appreciated that a financial instrument identifier is one or a combination of financial instrument specific keys corresponding to the one or plurality of subject financial instruments, and the financial instrument specific key or keys map the price level component 16 to a data table or data tables in the database 28. In this regard:
where the price level component 16 is presented to the active user 14.1 in a column matrix (such as 18.1 and 18.2), the financial instrument identifier comprises n-financial instrument specific keys where n is the number of subject financial instruments associated with the quote of the price level component 16 (by example, n = 3 for a butterfly as exemplified in FIG. 7, first row, as “1Y 3Y 5Y”), and
where the price level component 16 is presented to the active user 14.1 in a multi-column matrix (such as 18.3), the financial instrument identifier comprises a row key and column key in the matrix 18 (as exemplified in FIG. 8, first row first column, as “1Y” and “2Y”).

In providing input quote data to the interface module 12.1, the active user 14.1 clicks on a price level component 16.1 of an open tradable quote (visually indicated to the active user 14.1 through the price level component 16.1, which can be by means of colour coding of the price level component 16.1 background or, as in the examples of FIGS. 6, 7 and 8, with a cross-hatched background, or any other visual or textual indication as may be suitable for the interface module 12).

The price level component 16 functionality, as an interactive interface component, can be achieved through the use of a framework such as Blazor by Microsoft.

The open tradable quote in this example is a quote of a passive user 14.n as generated per example 3 below. In FIGS. 6 through 8 it can be seen that the price level component 16.1 of such an open tradable quote comprises a trade price level which (together with the visual indication of whether the price level component 16.1 is of an open tradable quote or not) is the only user accessible data available to the active user 14.1. As noted, the price level component 16.1 includes non-user accessible data comprising an identifier of the one or plurality of subject financial instruments (i.e. the financial instrument identifier) of the open tradable quote and whether the open tradable quote is a bid or an offer (i.e. the bid/offer status).

The active user 14.1 is then requested by the interface module 12.1, through a pop-up dialog box (not shown) derived from the user and non-user accessible data of the price level component 16.1, to provide and submit input quote data to the interface module 12.1 which then receives 110 same. The dialog box is so derived from the user and non-user accessible data that, where the price level component 16.1 is of an open tradable quote as an offer, the dialog box will request as part of the input quote data, an input amount which the active user 14.1 wishes to purchase, and where the price level component 16.1 is of an open tradable quote as a bid, the dialog box will request as part of the input quote data, an input amount which the active user 14.1 wishes to sell.

Accordingly, the interface module 12.1 receives 110 the input quote data of the active user 14.1 comprising of:
the financial instrument identifier and a buy/sell status derived from the bid/offer status of the price level component 16.1 which the active user 14.1 clicked;
the input amount which the active user 14.1 is interested in selling or buying; and
an input price level, matching the trade price level of the price level component 16.1 which the active user 14.1 clicked, at which the active user 14.1 is interested in selling or buying the input amount.

The input quote data is then passed from the interface module 12.1 to a business logic module 20 which receives 115 same. The business logic module 20 is shown in FIG. 1 to comprise, in part, of an application programming interface (API) module 22 and a data access module 26, with the API module 22 being disposed between the interface module 12.1 and the data access module 26.

The API module 22 includes a set of functions and the associated logic to relay the input quote data from the interface module 12.1 to the data access module 26 while the data access module 26 includes a set of functions and the associated logic to exchange data with a database 28 of financial instrument transaction data. This allows for consistent interaction with the database 28 and for the implementation of a combination of optimistic and pessimistic concurrency control measures described further below, while also ensuring that interface module 12 functionality is at no time exposed to the database 28, thereby ensuring financial instrument transaction data security as the API module 22 provides the only functions through which data can pass from and to an interface module 12 through the business logic module 20.

The API module 22, having received 115 the input quote data, then creates 120 an active user query object for which an object template is retrieved from an object template library 24. The active user query object informs parameters of a data exchange 125 with the database 28. Accordingly, the active user query object comprises:
an active user identifier,
the financial instrument identifier,
the input amount,
the input price level, and
the buy/sell status.

As part of optimistic and pessimistic concurrency controls, the exchange 125 comprises two consecutive exchanges to at all times ensure that the financial instrument transaction data from the database 28 is real time data.

A first exchange between the data access module 26 and the database 28 comprises:
retrieving a list of open tradable quotes of passive users 14.n with a defined price level at the input price level of the active user query object in the database 28 (it is to be appreciated that this need not be the case, and can include or be open tradable quotes of passive users with a defined price level which is more favourable to the active user than the input price level) for such open tradable quotes which have a bid/offer status commensurate with the buy/sell status of the active user query object; and
establishing a final list of executable tradable quotes from the list of all open tradable quotes retrieved.

In the above context, more favourable is to be understood in accordance with market convention with respect to the subject financial instrument(s) of the transaction. By example, in the case of equity stock, if the active user 14.1 wishes to buy an input amount of equity stock and a first passive user 14.n is selling same at a defined price level of $100 and a second passive user 14.n is selling same at a defined price level of $110, the price level of $100 is the more favourable price level for the active user 14.1. Consequently, in this case, the lower price level is more favourable. As a further example, certain financial instruments, such as bonds, are traded on yield (as the price level) and not price (as the price level) in certain markets. Consequently, in such a case, buying a bond at a higher interest rate (i.e. a higher defined price level) is more favourable to the active user 14.1 than a lower interest rate (i.e. a lower defined price level) as the interest rate is intended to be received by the active user 14.1. Further still, in the context of interest rate swaps as financial instrument(s), such financial instruments can involve the exchange of fixed interest rate payments for floating interest rate payments, and accordingly the concepts of buy and sell are themselves as per market convention which will therefore dictate whether a higher or lower price level are more favourable.

Once established, the data access module 26 returns the final list of executable tradable quotes to the API module 22.

In retrieving the list of all open tradable quotes of passive users 14.n, the data access module 26 retrieves such open tradable quotes for which the open tradable quote record has a quote status as “active”. The data access module 16 can further be configured to only retrieve such open tradable quotes generated by passive users 14.n within an ecosystem of the active user 14.1 (see below “users in the system” for an explanation of an ecosystem) or the API module 22 may be configured to filter out open tradable quotes generated by passive users 14.n not within an ecosystem of the active user 14.1.

The final list of executable tradable quotes is used in a second data exchange such that the associated open tradable quote record of an open tradable quote in the list is again retrieved from the database 28 so that any changes to parameters of an open tradable quote record since establishing the final list of executable tradable quotes (even if only milliseconds since the list has been established) can be taken into account in the second data exchange.

Accordingly, the second data exchange is sequential and iterates through the final list of executable quotes, an iteration comprising of the steps:
the API module 22 checking if the quote status of the associated open tradable quote record is set to “locked”, and if so, the API module 22 exiting the sequence and continuing with the next quote (i.e. a pessimistic concurrency control measure);
if the quote status is not set to “locked”, the API layer 22 passing the quote ID, the buy/sell status, a remaining amount of the input amount and an active user 14.1 identifier to the data access module 26;
the data access module 26 retrieving an open tradable quote record associated with the quote ID from the database 28;
the data access module 26 checking to determine whether the open tradable quote record does not have a quote status as “locked” and does have a quote status as “active” (i.e. a further pessimistic concurrency control measure);
if the quote status is determined to be “locked” and/or not “active” by the data access module 26, feedback is returned to the API module 22 upon which the API module 22 exiting the sequence and starting with the next quote;
sending instructions from the data access module 26 to the database 28 to create a trade record with a trade record ID (or individual trade records with associated trade record IDs) between the active user 14.1 and the open tradable quote;
if the trade record is not successfully created in the database 28, the API module 22 receiving feedback from the database 28 via the data access module 26 where in response (i.e. the optimistic concurrency control measure), the API module 22 exiting the sequence and starting with the next quote; and
where the trade record is created, the API module 22 determining the remaining amount from the input amount.

As is evident, a quote status of any tradable quote record can be a combination of statuses, such as “active” (as opposed to “filled” as seen below) and “locked” (as opposed to “unlocked” as seen below) per the above.

The feedback from the database 28 is an error condition noting that the trade record could not be created as a concurrency issue has been detected by the database 28. Where no such error condition is received by the data access module 26, a trade outcome result is returned to the API module 22.

It is to be appreciated that where the financial instrument transaction incorporates a plurality of financial instruments, a trade record comprises individual trade records and associated trade record IDs for each of the plurality of financial instruments (“legs”). Accordingly, a trade record can only be successfully created in the database 28 if each of the individual trade records can be successfully created in the database 28. This measure ensures that, where the open tradable quote associated with the quote ID of the iteration is associated with a set (plurality) of financial instruments, a trade record cannot be successfully created if only a portion of the associated individual trade records, each associated with a financial instrument (“leg”) of the open tradable quote, is created. In this event, the database 28 also passes an error condition to the data access module 26 and any created individual trade records are rolled back by the database 28 to ensure that all legs of the financial instrument transaction are present.

Where a trade record is created in the database 28 in an iteration of the second data exchange, a trade is realised between the active user 14.1 and the passive user 14.n on the open tradable quote of that iteration, and a quote status of the associated open tradable quote record is changed to “filled” in an instance where the defined amount of the open tradable quote is wholly depleted by the trade. The defined amount of the open tradable quote can also only be partially depleted by such a trade, in which case the quote status of the open tradable quote record remains as “active”, and the trade record so created in the database 28 can be used to determine the remaining defined amount of the open tradable quote for future trades.

When the second data exchange is concluded, the API module 22 generates 130 a financial instrument transaction outcome from the trade outcome result(s). The financial instrument transaction outcome can be one of:
a failure,
a partial success, and
a success.

A failure financial instrument transaction outcome would be generated 130 where no trade record could be created in the database 28.

A partial success financial instrument transaction outcome would be generated 130 where the second data exchange is concluded and the input amount has a surplus as the remaining amount after the final iteration. This could give rise to a process of executing a financial instrument transaction on a private tradable quote in terms of the “trader wants more” procedure as per examples 2 and 2.3 below.

A success outcome would be generated 130 where the remaining amount is determined to be wholly depleted either at the end of a final iteration of the second data exchange. Where the remaining amount is determined to be wholly depleted before the final list of executable quotes has been iterated through, a “quote has more” process as per example 1.1 below can be included as part of the second data exchange.

Where the financial instrument transaction outcome is a success or a partial success, the financial instrument transaction is executed and comprises the trade or trades so realised during the second data exchange. In this regard, it is to be appreciated that the financial instrument transaction can comprise one or a plurality of trades, depending on the input amount of the active user 14.1 and the defined amounts of the open tradable quotes in the final list of executable tradable quotes for which a trade is realised. Where a financial instrument transaction comprises a plurality of trades, it will be appreciated that the transaction can comprise trades realised on open tradable quotes of different passive users and not only a single passive user.

Upon generating 130 the financial instrument transaction outcome, each of the interface modules 12.1 to 12.n is sent 135 a notification via a notification module 30 to update the interface module 12 in accordance with the financial instrument transaction outcome through updating the price level component matrix or matrices 18 comprising the price level component or components 16 of the open tradable quote or quotes on which the trade or trades are realised.

### Example 1.1: Quote Has More

An instance may occur wherein the remaining amount is determined to be wholly depleted during an iteration of the second data exchange and the defined amount of the open tradable quote of the iteration remains only partially depleted, i.e. has a surplus. This instance can be referred to as “quote has more” as there remains available a portion of the defined amount of the open tradable quote.

In such an instance, the iteration in question is the last iteration of the second data exchange, and after determining the remaining amount is depleted, this last iteration includes the steps of:
setting the quote status of the open tradable quote record associated with the open tradable quote to “locked” (as a pessimistic concurrency control measure to ensure that during the succeeding steps of the last iteration, the open tradable quote is not the subject of a trade with a user 14 in the system 10 other than the active user 14.1);
sending a notification to the interface module 12.1 of the active user 14.1 via the notification module 30, the notification comprising the financial instrument identifier, the input price level and an option to the active user 14.1 to provide a further input amount via a pop-up dialog box presented to the active user 14.1 via the interface module 12.1;
optionally, receiving from the active user 14.1 the further input amount via the interface module 12.1 of the active user 14.1;
where the further input amount is received from the active user 14.1:
   passing the further input amount to the data access module 26 from the interface module 12.1 of the active user 14.1 via the API module 22, and
   the data access module 26 sending instructions to the database 28 to create a trade record between the active user 14.1 and a passive user 14.n of the open tradable quote.

This option to the active user 14.1 is preferably available for only a predetermined time period so as to ensure that the active user 14.1 cannot unreasonably restrict other users 14 in the system 10 to execute a financial instrument transaction comprising of a trade on the open tradable quote in question. After the predetermined time period, where no further input amount is received from the active user 14.1, the quote status of the open tradable quote record associated with the open tradable quote will be set to “unlocked”.

As the surplus in the defined amount of the open tradable quote is not disclosed in the notification to the active user 14.1 (ensuring the necessary data privacy of the passive user 14.n), the further input amount of the active user 14.1 may be equal to, greater or less than the surplus in the defined amount. Where the further input amount is equal to or less than the surplus in the defined amount, the trade record created between the active user 14.1 and the passive user 14.n of the open tradable quote in the database 28 will be for an amount equal to the further input amount.

Where the further input amount is greater than the surplus in the defined amount, the trade record created between the active user 14.1 and the passive user 14.n of the open tradable quote in the database 28 will be for an amount equal to the surplus.

In this regard, if the trade record is for an amount equal to the surplus, the quote status of the open tradable quote record associated with the open tradable quote is set to “filled” after the second data exchange. If the trade record is for an amount less that the surplus, the quote status of the open tradable quote record associated with the open tradable quote remains as “active” after the second data exchange.

### Example 2: Executing a Peer-To-Peer Financial Instrument Transaction on A Private Tradable Quote

This example is with reference to FIGS. 1 and 3 showing the system 10 for executing a peer-to-peer financial instrument transaction and the process of executing such a financial instrument transaction on a private tradable quote.

In this regard, a private tradable quote is a quote which is generated in the system 10, but is a tradable quote which is only presented to a specific active user 14.1 as separate from open tradable quotes which are presented to a plurality of users 14 in the system, such as an ecosystem of users 14, by means of price level components 16.1 in price level component matrices 18. Accordingly, a private tradable quote record in the database 28 associated with the private tradable quote comprises:
an active user identifier;
a passive user identifier of the passive user 14.n of the private tradable quote;
a financial instrument identifier;
a bid/offer status;
a private quote price level; and
a private quote amount.

The process of executing a peer-to-peer financial instrument transaction on such a private tradable quote therefore starts with presenting 210 an option to execute a financial instrument transaction on the private tradable quote to the active user 14.1 (associated with the active user identifier) via an interface module 12.1 of the active user 14.1. Where the interface module 12.1 is an electronic web user interface, this option can be presented as a pop-up dialog box (not shown) which includes the financial instrument identifier, the bid/offer status, the private quote price level and the private quote amount of the private tradable quote.

The active user 14.1 may then elect to execute a financial instrument transaction on the private tradable quote by providing private input quote data via the dialog box to the interface module 12.1 and the interface module 12.1 receiving 220 same. This private input quote data can comprise only a private quote identifier, as the option afforded to the active user 14.1 is with reference to the financial instrument identifier, the bid/offer status, the private quote price level and the private quote amount of the private tradable quote so presented to the active user 14.1. Consequently, by providing the private input quote data, the active user 14.1 merely indicates his acceptance of the option.

This private input quote data is then passed 230 via the API module 22 of the business logic module 20 to the data access module 26, which in turn sends 240 instructions comprising the private input quote data to the database 28 to create a trade record with an associated trade record ID between the active user 14.1 and a passive user 14.n of the private tradable quote, and thereby executing the financial instrument transaction between the active user 14.1 and the passive user 14.n.

As the option on the private tradable quote is presented only to the active user 14.1, and at the private quote price level and the private quote amount, the data exchange of example 1 is not required.

As with example 1, where the private tradable quote is of a set (plurality) of financial instruments, the trade record will comprise individual trade records and associated trade record IDs, each corresponding to a financial instrument (“leg”) in the financial instruments.

Once the trade record is created and thereby the financial instrument transaction is executed, a notification is sent 250 via the notification module 30 to the interface module 12.1 of the active user 14.1 to update the interface module 12.1 in accordance with the trade record so created. As noted, the system 10 includes an interface module 12.n of the passive user 14.n, and the notification can be sent to the interface module 12.n of the passive user 14.n so as to also update same in accordance with the trade record so created.

### Example 2.1: Request for Quote Process

Further referring to FIGS. 1 and 3, the step of presenting an option to execute a financial instrument transaction on the private tradable quote to the active user 14.1 via the interface module 12.1 of the active user 14.1 may be preceded by a request for quote (RFQ) process. The RFQ process involves the active user 14.1 prompting users 14 (which can be passive users 14.n in an ecosystem of the active user 14.1) in the system 10 to generate private tradable quotes.

In this regard, the active user 14.1 clicks on a price level component 16.2 (as shown in FIGS. 6, 7 and 8) of an indicative market price level quote (which can be visually or textually indicated to the active user 14.1 through the price level component 16.2, and in the examples of FIGS. 6, 7 and 8 so indicated by means of a non-cross-hatched background of the price level component 16.2) associated with one or a plurality (set) of financial instruments which the active user 14.1 wishes to purchase, sell or exchange by means of a financial instrument transaction. This price level component 16.2 in the example is presented to the active user 14.1 as part of a price level component matrix 18 (which may also present price level components 16.1 of open tradable quotes to the active user 14.1, but in this instance:
there may not be open tradable quotes available to the active user 14.1 which are associated with the one or plurality (set) of financial instruments which the active user 14.1 wishes to purchase, sell or exchange,
such open tradable quote(s) may exist but at a trade price level which is not acceptable to the active user 14.1, or
the active user 14.1 wishes to execute a financial instrument transaction at a specific total amount and wishes the financial instrument transaction to include the total amount else not be executed at all.

Where the price level component 16 is of an indicative market price level quote, the price level component 16.2 comprises, as user accessible data, a market price level, and as non-user accessible data, the financial instrument identifier and a bid/offer status based on whether the indicative market price level quote is of the purchase or sale of the one or plurality of subject financial instruments.

This market price level relates to the price level of the financial instrument type(s) of the one or plurality of subject financial instrument(s) when bought or sold in a given market (which market price level can be obtained programmatically from known market price level sources such as Bloomberg online market data via the associated API). It is to be appreciated that, where an indicative market price level quote is of a plurality (set) of financial instruments, a singular market price level would be calculated in accordance with market convention.

In response to clicking on the price level component 16.2 of an indicative market price level quote, the active user 14.1 is presented with a pop-up dialog box requesting the active user 14.1 to provide an RFQ amount which the active user 14.1 is interested in purchasing, selling or exchanging. The active user 14.1 may then submit same, and the interface module 12.1 accordingly receives RFQ response quote data comprising of:
the financial instrument identifier obtained from the price level component 16.2; and
an RFQ amount which the active user 14.1 is interested in buying or selling.

Preferably, the RFQ response quote data would not include a buy/sell status as a subsequent request for a private tradable quote does not have to be a specific request for a private tradable quote as a bid or an offer. This measure would ensure data privacy for the active user 14.1.

The RFQ response quote data is then relayed from the interface module 12.1 to the API module 22 and the API module 22 creates an RFQ object (for which a template is retrieved from the object template library 24). This RFQ object comprises:
the financial instrument identifier, and
the RFQ amount.

In response to creating the RFQ object, an RFQ notification is sent via the notification module 30 to one or a plurality of interface modules 12.n of passive users 14.n (such as users 14.1 in the active user’s 14.1 ecosystem, see below “users in the system” for an explanation of an ecosystem). The interface module or modules 12.n in response then presents an RFQ notice to its associated passive user 14.n via a pop-up dialog box comprising:
a display of the financial instrument identifier and the RFQ amount as obtained from the RFQ record; and
a request for a private tradable quote.

This request for a private tradable quote is then open to the passive user 14.n for a market related predetermined time period (such as 30 seconds, preferably less than 60 seconds depending on the market and the nature of the financial instrument(s)). The passive user 14.n, in response to the RFQ notice, may then opt to generate 150 a private tradable quote by creating a private tradable quote record in the database 28 during this predetermined time period. Such a private tradable quote record comprises:
the financial instrument identifier;
a quote status as “private”;
an active user identifier;
a passive user identifier of the passive user 14.n of the private tradable quote;
a bid/offer status;
a defined price level; and
a private quote amount as the RFQ amount.

The quote status as “private” and the active user identifier is used to send an RFQ notice to the interface module 12.1 of the active user 14.1 via the notification module 30, in response to which an option to execute a financial instrument transaction on the private tradable quote is presented 210 to the active user 14.1.

The RFQ notice of the active user 14.1 is only sent after the predetermined time period expires and can comprise one or a plurality of options, each associated with a private tradable quote generated by a passive user 14.n in response to the passive user’s 14.n RFQ notice. Preferably, an option associated with a private tradable quote having the best defined price level corresponding to its bid/offer status is presented to the active user 14.1.

### Example 2.2: Trader Wants More

As noted in example 1.1, an instance may occur after the second data exchange wherein the remaining amount of the input amount has a surplus after the final list of executable quotes has been iterated through. This instance is referred to as “trader wants more” as the active user 14.1 still has an amount remaining of the input amount which the active user 14.1 is interested in trading.

In such an instance, after the second data exchange is concluded and the transaction is executed, the system 10 automatically generates a private tradable quote by creating a private tradable quote record in the database 28 on behalf of the active user 14.1 who now becomes a passive user 14.n. This private tradable quote record comprises:
the financial instrument identifier of the active user query object;
a quote status as “private”;
an active user identifier;
a passive user identifier of the now passive user 14.n of the private tradable quote;
a bid/offer status commensurate with a trade direction of the option;
a private quote amount as the remaining amount after the second data exchange; and
a private quote price level as the input price level.

The active user reference is of one or a plurality of passive user or users 14.n who generated the open tradable quote or quotes in the final list of executable tradable quotes.

Once the private tradable quote record is created in the database 28, a notification is sent via the notification module 30 to the interface module or modules 12.n of the passive user or users 14.n identified by means of the active user reference (these passive user(s) 14.n now becoming active users 14.1), wherein response, the interface modules 12.1 present 210 an option to execute a financial instrument transaction on the private tradable quote.

### Example 3: Generating an Open Tradable Quote in the System

This is example is with reference to FIGS. 1 and 4 showing the system 10 for executing a peer-to-peer financial instrument transaction of which the system and associated process for generating a quote as an open tradable quote forms part. In this example the interface module 12 is again an electronic web user interface.

To generate an open tradable quote in the system 10, a user 14 clicks on a price level component 16.2 (as shown in FIGS. 6, 7 and 8) of an indicative market price level quote (which can be visually or textually indicated to the user 14 through the price level component 16.2, shown in FIGS. 6, 7 and 8 to be by means of a non-cross-hatched background of the price level component 16.2) presented by the interface module 12.

The user 14 is then presented with a dialog box (not shown) in the interface module 12 querying whether the user 14 wishes to generate an open tradable quote. As the price level component 16.2 includes non-user accessible data comprising of an identifier of the associated one or plurality of financial instruments and whether the indicative market price level quote of the price level component 16.2 is of a bid or an offer, the dialog box can be specific to the indicative market price level quote so clicked as well as to the one or plurality of financial instruments associated with same.

With reference to the one or plurality of financial instruments associated with the indicative market price level quote, the user 14 may then opt to provide a defined amount which the user 14 commits to buy or sell as well as a defined price level at which the user 14 commits to so buy or sell, and submit same, with the interface module 14 receiving 310 same as part of tradable quote data. This tradable quote data therefore comprises:
the financial instrument identifier, a quote type identifier and a bid/offer status obtained from the price level component 16.2,
the defined amount, and
the defined price level.

The quote type identifier allows the system 10 to identify whether the open tradable quote to be generated is associated with one or a plurality of financial instruments as well as the financial instrument type(s).

The tradable quote data is then passed 320 from the interface module 12 to the business logic module 20. As shown in FIG. 1 and explained in example 1, the business logic module comprises in part of the API module 22 and the data access module 26, with the API module 22 disposed between the interface module 12 and the data access module 26.

Accordingly, the API module 22 receives the tradable quote data from the interface module 12 and in turn creates a tradable quote object comprising the tradable quote data from an object template retrieved from the object template library 24. The object template so retrieved is based on the quote type identifier and the tradable quote object includes the quote type identifier and the financial instrument identifier so that in the downstream process, the correct data fields in the database 28 can be identified in which to populate the parameters of a corresponding open tradable quote record when created in the database 28.

The API module 22 passes this tradable quote object to the data access module 26 and accordingly, the data access module 26 receives the tradable quote data as part of the tradable quote object. The data access module 26 then creates 330 the open tradable quote record and associated quote ID in the database 28 from the tradable quote object to generate an open tradable quote in the system 10. This open tradable quote record includes a quote status as “active”. Accordingly, once the interface module 12 has received the tradable quote data of the user 14, the user 14 becomes a passive user 14.n (such as in an ecosystem of users 14, see below “users in the system” for an explanation of an ecosystem).

Finally, once the open tradable quote record has been created 330 in the database 28, a notification is sent 340 via the notification module 30 to the interface modules 12 of users 14 (such as users 14 in the ecosystem of the now passive user 14.n) and thereby the interface modules 12 receives 410 (as shown in FIG. 5) an instruction to generate a price level component matrix 18 (of which a price level component 16.1 of the now generated open tradable quote forms a part) in terms of the process of presenting a price level component matrix 18 per example 4 below (accordingly, this notification can merely be a refresh command, wherein now this generated open tradable quote will form part of an open tradable quote list for a cell 19 in the matrix 18 corresponding to the one or set of financial instruments of this generated open tradable quote).

### Example 4: Presenting a Price Level Component Matrix in an Interface Module of the System

This example is with reference to FIGS. 1 and 5 showing the system 10 for executing a peer-to-peer financial instrument transaction in which a process for presenting a price level component matrix in an interface module 12 of the system 10 occurs. In this example the interface module 12 is again an electronic web user interface.

FIG. 5 shows that the process for presenting a price level component matrix 18 in an interface module 12 starts with the interface module 12 receiving 410 an instruction to generate a price level component matrix 18 (as exemplified in FIGS. 6 through 8) comprising one or a plurality of cells 19 (i.e. in this regard a matrix 18 can comprise a singular cell 19, and as such, a single cell matrix can form part of a combination of single cell matrices). A cell 19 in the matrix 18 is shown to comprise one (19.1) or a plurality (19.2 and 19.3) of price level components 16 of quotes associated with one or a plurality of subject financial instruments.

This instruction to generate the price level component matrix 18 can occur in the event of one or a combination of:
a change in a state of an open tradable quote of a price level component 16 of the matrix 18, the state referring to any parameter associated with the open tradable quote record of the open tradable quote, such as the quote status;
a change in a state of an ecosystem of the user 14 associated with the interface module 12, i.e. when the user 14 changes party authorisations (see below “users in the system” for an explanation of an ecosystem and authorisation in this context);
when a trade is realised on the one or plurality of quotes as an open tradable quote as described in examples 1 and 3 above; and
an interface module 12 refresh or load command, such as on user 14 login to the system 10.

It is therefore to be appreciated that “generate” with reference to the price level component matrix 18 can also mean producing an update of, i.e. updating, an existing price level component matrix. In the instance of a combination of single cell matrices 18, there can be the generation of a single cell matrix 18 in the combination while the remaining single cell matrices 18 of the combination remain unchanged.

As shown in FIG. 1, the business logic module 20 comprises the API module 22, a matrix data structuring module 32 (hereafter referred to as a factory module) and the data access module 26. In this regard, the API module 22 relays a request 420 to generate the price level component matrix and request data from the interface module 12 to the factory module 32. This request data comprises a matrix identifier of the matrix 18 to be generated as well as a user 14 identifier.

The factory module 32 then retrieves 430 a quote data map object corresponding to the price level component matrix 18 to be generated from the object template library 24. This quote data map object to be retrieved is specified by the matrix identifier and corresponds in structure to that of the matrix 18 to be generated (i.e. whether the matrix 18 is a column matrix or a multi-column matrix). By example, a quote data map object structure can be defined for:
a multi-column matrix for quotes associated with n-financial instruments (such as n = 1 for a forward, n = 2 for a spread or any number of financial instruments by any market convention); and
a column matrix for quotes associated with n-financial instruments (such as n = 1 in the case of an outright purchase or sale, n = 2 in the case of a pack, n = 3 in the case of a butterfly, or any number of financial instruments by any market convention).

Accordingly, the quote data map object structure is not specific to the financial instruments associated with quotes of price level components of the matrix 18. The keys as the financial instrument identifier(s) (as part of the matrix identifier, and where the matrix 18 to be generated is a multi-column matrix, the matrix identifier includes a bid/offer identifier as multi-column matrices in the system 10 only relate to one of quotes as bids or offers) are then provided in the quote data map object structure to obtain the correct quotes in the database 28. Therefore, the quote data map object maps quote records of the one or plurality of subject financial instruments of the one or plurality of price level components in the database 28 to the one or plurality of cells 19 of the price level component matrix 18 to be generated.

Once the quote data map object is retrieved 430 by the factory module 32 from the object template library, the quote data map object is populated with keys, and the factory module iterates 440 through each of the cells 19 of the price level component matrix 18 to be generated. In each iteration the factory module 32, via the data access module 26, firstly retrieves 450 an open tradable quote list from the database 28 corresponding to the cell 19 by means of the quote data map object, according to the key(s) of the cell 19 of the matrix 18 to be generated, and then creates 370 a cell-specific final quote list.

In creating a cell-specific final quote list, the factory module 32 firstly filters the associated open tradable quote list so retrieved so that only open tradable quotes associated with an open tradable quote record with a quote status as active are retained. The factory module 32, where necessary, can also filter the associated open tradable quote list so retrieved so that only open tradable quotes of users 14 in an ecosystem of the user 14 of the interface module 12 are retained. The filtered open tradable quotes are then sorted in ascending or descending order from best price level to worst price level for bids and offers in accordance with market convention and according to the financial instrument type. Furthermore, for the system 10 to promote liquidity in the market, the factory module 32 can also opt to only retain an open tradable quote of another user 14 at the top of the list, once sorted, if an open tradable quote from the user 14 of the interface module 12 does not exist in the tradable quote list retrieved (i.e. a user 14 would be encouraged to generate an open tradable quote per example 2 as then greater market depth is shown to the user 14).

It is further to be appreciated that the creating 470 of a cell-specific final quote list can, where necessary, include generating 460 an indicative market price level quote from a real time market price of each of the one or plurality of subject financial instruments and adding it to the cell-specific final quote list. The real time market price of each of the one or plurality of subject financial instruments can be obtained programmatically from a source such as Bloomberg as known to those skilled in the art.

Using the cell-specific final quote list for each of the one or plurality of cells 19 in the price level component matrix 18 to be generated, the factory module 32 generates 480 a matrix object (as a matrix of data wherein each cell of the matrix comprises a cell-specific final quote list). This matrix object is then passed 490 via the API module 22 to the interface module 12 where the price level component matrix 18 is rendered 500 by the interface module 12 and presented 510 to the user 14.

Accordingly, in all instances, the interface module 12 only receives one of two matrix structures: a column matrix or a multi-column matrix, and therefore the interface module 12 functions and associated logic can remain financial instrument agnostic in rendering 500 and presenting 510 a price level component matrix 18. After the price level component matrix 18 is presented 510 to the user 14, the user 14 may in turn be an active user 14.1 and/or a passive user 14.n in accordance with any of the preceding examples.

It is to be appreciated that where the associated logic of the interface module 12 is executed user-side in the browser (such as through Microsoft

Blazor WebAssembly), the matrix object comprises only of price levels of each quote (together with a discriminator for whether the quote is one of an open tradable quote or an indicative market price level quote) in each cell-specific final quote list for each of the one or plurality of cells to ensure that no further data associated with the quote(s) in a cell-specific final quote list may be by any means accessible to the user 14. However, where the associated logic of the interface module 12 is executed server side (such as through Microsoft Blazor Server), the matrix object comprises the price levels, the financial instrument identifiers, the bid/offer status and optionally the quote type identifiers of each quote in each cell-specific final quote list for each of the one or plurality of cells.

### Users in the System

The active user 14.1 in the present context is a user 14 in the system 10 who attempts to execute a financial instrument transaction on a quote in the system 10, where the quote can be an open or private tradable quote of a passive user 14.n.

The interaction between active users 14.1 and passive users 14.n in the system 10 is important as, depending on the market and the parties to financial instrument transactions therein, all users 14 in the system 10 may or may not be authorised to transact with all other users 14 in the system 10. The allowable transacting between users 14 in the system 10 represents an ecosystem.

Where it may be required and/or preferred, a passive user 14.n in this regard may be limited to a representative of a first party (or is the first party), where the passive user 14.n has authorised transacting of the one or a plurality of subject financial instruments between the first party and a second party of which the active user 14.1 is a representative (or the active user 14.1 being the second party), and furthermore which active party 14.1 has reciprocally authorised transacting of the one or a plurality of subject financial instruments between the second party and the first party.

Consequently, in such specific circumstances an active user 14.1 in the system 10 may at any time only be presented price level components 16 (whether in a price level component matrix 20 or otherwise) of:
quotes as indicative market price level quotes;
tradable quotes as generated by a passive user 14.n of, or as, such a first party; and
tradable quotes as generated by the active user or a passive user 14.n also being of, or as, the second party.

Data security, concurrency and real time results of the system

From the above, it is apparent that the system 10 and associated data control infrastructure and processes, through consistent interaction with the database 28 and architecture which allows the implementation of a combination of optimistic and pessimistic concurrency control measures, enables viable execution of peer-to-peer financial instrument transactions while ensuring data privacy and security throughout the transaction process.

Furthermore, by allowing for the retrieval of data form the database 28 at the latest possible step in any process through the data access module 26, the system 10 ensures that no user-exposed or machine-exposed interface module 12 functionality can make unregulated exchanges with the database 28 while also ensuring use of real time financial instrument transaction data in processing information from and to the interface module 14, which is fundamental in a system 10 which will experience high financial instrument transaction volumes. This, in combination with the concurrency control measures, ensures that at any point, a user 14 in the system 10 is presented with real time actionable market information at a level of accuracy and security which is not known to date.

1. A system for executing a peer-to-peer financial instrument transaction, the system comprising:
an interface module of an active user of the system, the interface module for:
presenting a price level component of an open tradable quote associated with one or a plurality of subject financial instruments to the active user, and
receiving input quote data of the active user;
a business logic module for:
receiving the input quote data from the interface module,
exchanging data with a database of financial instrument transaction data by means of the input quote data to execute the financial instrument transaction, and
generating a financial instrument transaction outcome from the data exchange; and
a notification module for sending a notification on the financial instrument transaction outcome to the interface module and thereby updating the interface module.

2. The system of claim 1, wherein the business logic module exchanges data with the database by means of the input quote data through creating an active user query object from the input quote data and exchanging data with the database through the active user query object comprising the input quote data.

3. The system of claim 2, wherein the business logic module comprises an application programming interface (API) module and a data access module, the API module disposed between the interface module and the data access module.

4. A process for executing a peer-to-peer financial instrument transaction on an open tradable quote, the process comprising the steps of:
presenting via an interface module a price level component of an open tradable quote associated with one or a plurality of subject financial instruments to an active user of the system;
receiving via the interface module input quote data of the active user;
receiving at a business logic module the input quote data from the interface module;
exchanging data with a database of financial instrument transaction data via the business logic module by means of the input quote data to execute the financial instrument transaction;
generating a financial instrument transaction outcome from the data exchange in the business logic module; and
sending a notification on the financial instrument transaction outcome to the interface module via a notification module and thereby updating the interface module.

5. The process of claim 4, wherein the price level component comprises, as user accessible data, a trade price level, and as non-user accessible data, a financial instrument identifier and a bid/offer status indicating whether the open tradable quote is a bid or an offer.

6. The process of claim 5, wherein the input quote data comprises:
a financial instrument identifier and a buy/sell status;
an input amount which the active user is interested in selling or buying; and
an input price level at which the active user is interested in selling or buying the input amount.

7. The process of claim 6, wherein the step of exchanging data with the database comprises a first data exchange, the first data exchange comprising the steps of:
retrieving via the business logic module a list of open tradable quotes of passive users with a defined price level at and/or more favourable for the active user than the input price level in the database for such open tradable quotes which have a bid/offer status commensurate with the buy/sell status; and
establishing a final list of executable tradable quotes from the list of all open tradable quotes retrieved in the business logic module.

8. The process of claim 7, wherein the step of exchanging data with the database comprises a second data exchange subsequent the first data exchange, the second data exchange iterating through the final list of executable tradable quotes by open tradable quote, an iteration comprising the steps of:
retrieving via the business logic module an open tradable quote record associated with the open tradable quote from the database;
sending instructions via the business logic module to the database to create a trade record between the active user and a passive user of the open tradable quote;
if the trade record is not successfully created in the database, the business logic module receiving feedback from the database where in response, the business logic module exiting the sequence and starting with the next open tradable quote in the final list of executable tradable quotes; and
where the trade record is successfully created, determining via the business logic module a remaining amount from the input amount.

9. The process of claim 8, wherein if the financial transaction outcome is a partial success or a success, the financial instrument transaction is executed comprising one or a plurality of trades for which a trade record is created in the database.

10. The process of claim 9, wherein if during an iteration of the second data exchange, the remaining amount is wholly depleted by a trade, and a defined amount of the open tradable quote of that iteration is not wholly depleted by the trade, the iteration is the last iteration of the second data exchange, the last iteration, subsequent to determining the remaining amount, including the steps of:
sending a notification to the interface module of the active user via the notification module, the notification comprising the financial instrument identifier, the input price level and an option to the active user to provide a further input amount;
receiving from the active user the further input amount via the interface module of the active user; and
where the further input amount is received from the active user:
passing the further input amount to the business logic module from the interface module of the active user, and
sending instructions from the business logic module to the database to create a trade record between the active user and a passive user of the open tradable quote.

11. The process of claim 9, wherein if, at conclusion of the second data exchange, the remaining amount of the input amount is not wholly depleted, the process includes a step of generating a private tradable quote of the active user, the active user thereby a passive user in the process of executing a peer-to-peer financial instrument transaction on a private tradable quote including:
presenting an option to execute a financial instrument transaction on the private tradable quote to an active user via an interface module, the option including a financial instrument identifier, a private quote price level and a private quote amount of the private tradable quote;
receiving private input quote data of the active user via the interface module;
passing the private input quote data to a business logic module;
sending instructions comprising the private input quote data from the business logic module to a database of financial instrument transaction data to create a trade record between the active user and a passive user of the private tradable quote; and
sending a notification to the interface module via a notification module informing of the trade record and thereby updating the interface module.

12. The process of claim 1, wherein the private tradable quote comprises:
the financial instrument identifier;
an active user reference;
a bid/offer status;
a private quote amount; and
a private quote price level as the input price level.

13. The process of claim 12, wherein the private quote amount is the remaining amount on concluding the second data exchange.

14. The process of claim 4, wherein the step of exchanging data with the database is preceded by a step of creating an active user query object from the input quote data in the business logic module, and thereby the step of exchanging data with the database is by means of the active user query object comprising the input quote data.

15. The process of claim 14, wherein the active user query object comprises:
an active user identifier;
the financial instrument identifier;
the input amount;
the input price level; and
the buy/sell status.

16. A process for executing a peer--to--peer financial instrument transaction on a private tradable quote, the process comprising the steps of:
presenting an option to execute a financial instrument transaction on the private tradable quote to an active user via an interface module, the option including a financial instrument identifier, a private quote price level and a private quote amount of the private tradable quote;
receiving private input quote data of the active user via the interface module;
passing the private input quote data to a business logic module;
sending instructions comprising the private input quote data from the business logic module to a database of financial instrument transaction data to create a trade record between the active user and a passive user of the private tradable quote; and
sending a notification to the interface module via a notification module informing of the trade record and thereby updating the interface module.

17. The process of claim 16, wherein the private input quote data comprises of a private quote identifier.

18. The process of claim 17, wherein the step of presenting an option to execute a financial instrument transaction on the private tradable quote to the active user via an interface module is preceded by a request for quote (RFQ) process, the RFQ process comprising the steps of:
receiving RFQ response quote data of the active user via the interface module;
passing the RFQ response quote data from the interface module to the business logic module;
creating an RFQ object in the business logic module;
sending an RFQ notification via the notification module to an interface module of a passive user and thereby displaying an RFQ notice to the passive user; and generating a private tradable quote of the passive user in the system, the private tradable quote comprising a private quote price level, a private quote amount and an active user reference.

19. The process of claim 18, wherein the RFQ response quote data is received via the interface module by means of a price level component of an indicative market price level quote.

20. The process of claim 19, wherein the RFQ response quote data comprises a financial instrument identifier and an RFQ amount which the active user is interested in buying or selling.

21-31. (canceled)

32. The process of claim 20, wherein the RFQ object comprises the financial instrument identifier and the RFQ amount.

33. The process of claim 32, wherein the private tradable quote comprises the financial instrument identifier, an active user reference, a passive user defined bid/offer status, a private quote amount and a private quote price level as a passive user defined price level.

34. A system for generating an open tradable quote in a peer-to-peer financial instrument transaction, the system comprising:
an interface module for:
receiving tradable quote data associated with one or a plurality of subject financial instruments of a user in the system, the tradable quote data comprising a financial instrument identifier, a bid/offer status, a defined amount and a defined price level;
a business logic module for:
receiving the tradable quote data from the interface module, and
creating an open tradable quote record in a database of financial instrument transaction data from the tradable quote data, and thereby generating the open tradable quote; and
a notification module for sending a notification to the interface module informing of the creation of the open tradable quote record.

35. The system of claim 34, wherein the business logic module comprises of an application programming interface (API) module and a data access module, the API module disposed between the interface module and the data access module, the API module for:
receiving the tradable quote data from the interface module and creating a tradable quote object comprising the tradable quote data from an object template retrieved from an object template library, the object template based on a quote type identifier of the tradable quote data; and
passing the tradable quote object comprising the tradable quote data to the data access module to create the open tradable quote record in the database.

36. A process for generating an open tradable quote in a peer-to-peer financial instrument transaction, the process comprising the steps of:
receiving via an interface module, tradable quote data associated with one or a plurality of subject financial instruments of a user, the tradable quote data comprising a financial instrument identifier, a bid/offer status, a defined amount and a defined price level;
passing the tradable quote data from the interface module to a business logic module;
creating via the business logic module, an open tradable quote record in a database of financial instrument transaction data from the tradable quote data, and thereby generating the open tradable quote; and
sending via a notification module, a notification to the interface module informing of the creation of the open tradable quote record.

37. A process for presenting a price level component matrix in an interface module of a system for executing a peer-to-peer financial instrument transaction, the process comprising the steps of:
receiving via the interface module an instruction to generate the price level component matrix comprising one or a plurality of cells, a cell comprising one or a plurality of price level components, each price level component of a quote associated with one or a plurality of subject financial instruments;
requesting via the interface module a business logic module to generate a matrix object of the price level component matrix to be generated;
generating in the business logic module the matrix object comprising of a price level for each quote of the one or plurality of price level components of the one or plurality of cells in the price component matrix;
passing the matrix object from the business logic module to the interface module;
rendering the price level component matrix by means of the matrix object in the interface module; and
presenting in the interface module the price level component matrix so rendered.

38. The process of claim 37, wherein the step of requesting the business logic module to generate the matrix object includes passing request data comprising a matrix identifier from the interface module to the business logic module.

39. The process of claim 38, wherein the step of generating the matrix object comprises the steps of:
generating via the business logic module a quote data map object corresponding to the price level component matrix to be generated as specified by the matrix identifier, the quote data map object mapping quote records of the one or plurality of subject financial instruments of the one or plurality of price level components in a database of financial instrument transaction data to the one or plurality of cells of the price level component matrix to be generated; and
creating a cell-specific final quote list via the business logic module by means of the quote data map object.

40. The process of claim 39, wherein the step of creating the cell-specific final quote list includes the step of, for each of the one or plurality of cells, retrieving an open tradable quote list from the database corresponding to the cell by means of the quote data map object via the business logic module.

41. The process of claim 40, wherein the step of creating the cell-specific final quote list includes a step of generating an indicative market price level quote from a real time market price of each of the one or plurality of subject financial instruments.

42. The process of claim 38, wherein the business logic module comprises an application programming interface (API) module, a matrix data structuring module and a data access module, the matrix data structuring module for generating the matrix object, and the API module for relaying the request to generate the price level component matrix and the request data from the interface module to the matrix data structuring module and relaying the matrix object from the matrix data structuring module to the interface module.
